(19) United States
(12) Patent Application Publication
(10) Pub. No.: US 2024/0351354 A1
(43) Pub. Date: Oct. 24, 2024

(54) INKJET PRINTER

(71) Applicant: Roland DG Corporation, Hamamatsu-shi (JP)

(72) Inventors: Ryosuke NONAKA, Hamamatsu-shi (JP); Misaki KONISHI, Hamamatsu-shi (JP); Naomi YAMAMURA, Hamamatsu-shi (JP)

(21) Appl. No.: 18/640,041

(22) Filed: Apr. 19, 2024

(30) Foreign Application Priority Data
Apr. 20, 2023 (JP) 2023-069502
Apr. 17, 2024 (JP) 2024-066965

(51) Int. Cl. B41J 11/58; B41J 11/00; B41J 29/02

(52) U.S. Cl. CPC B41J 11/58; B41J 11/007; B41J 29/02

(57) ABSTRACT

A printer includes a roll paper holder to hold a roll paper, and a support holder to support the roll paper holder such that the roll paper holder is detachable and rotatable. The roll paper holder includes a rotation shaft, a first flange secured to the rotation shaft, a second flange provided on the rotation shaft, and a positioning flange provided on the rotation shaft and located at a predetermined position to the right of the first flange. The support holder includes a position determiner including an insertion hole housing a portion of the positioning flange in a state where the roll paper holder is rotatably supported and also including a restriction wall partitioning the insertion hole and restricting the positioning flange from moving in a main scanning direction.

### CROSS REFERENCE TO RELATED APPLICATION

This application claims the benefit of priority to Japanese Patent Application No. 2023-69502 filed on Apr. 20, 2023 and Japanese Patent Application No. 2024-66965 filed on Apr. 17, 2024. The entire contents of this application are hereby incorporated by reference herein.

### BACKGROUND OF THE INVENTION

### 1. Field of the Invention

The present invention relates to inkjet printers.

### 2. Description of the Related Art

Conventionally, inkjet printers printing an image on a roll paper, which is a band-shaped recording medium wound into a cylindrical shape, are known. Such an inkjet printer includes an inkjet head movable in a first direction, a roll paper holder holding a roll paper, and a conveyor conveying the roll paper, unwound from the roll paper holder, in a second direction. For example, Japanese Patent No. 5447000 discloses an inkjet printer including, as a roll paper holder, a pair of spool flanges and a spool shaft having two ends at which the pair of spool flanges are secured. In Japanese Patent No. 5447000, the spool shaft is inserted into the roll paper, and then the spool flanges are inserted into two ends of the roll paper to cause the roll paper holder to hold the roll paper. Then, the spool shaft is set at a sheet roll support portion.

In Japanese Patent No. 5447000, in order to determine the position of the roll paper held by the roll paper holder, a guide restricting one of the spool flanges from moving is provided. However, the inkjet printer described in Japanese Patent No. 5447000 is configured such that the roll paper holder holding the roll paper is put into a main body of the inkjet printer through an opening formed in a front surface of the main body and the spool flanges are rolled to locate the wall paper holder at a predetermined position. The work of locating the roll paper holder at a proper position and then unwinding the roll paper from an end thereof is troublesome.

### SUMMARY OF THE INVENTION

Example embodiments of the present invention provide inkjet printers each allowing a roll paper holder, holding a roll paper, to be positioned with respect to a support holder easily and to be attached to the support holder easily.

An inkjet printer according to an example embodiment of the present invention includes a housing, an inkjet head provided in the housing and movable in a first direction to discharge ink toward a roll paper wound into a cylindrical shape, a roll paper holder to hold the roll paper, a support holder provided in the housing to support the roll paper holder such that the roll paper holder is detachable and rotatable, and a conveyor to convey the roll paper, held by the roll paper holder, in a second direction perpendicular to the first direction as seen in a plan view, wherein the roll paper holder includes a rotation shaft extending in the first direction, a first flange secured to an end of the rotation shaft on one of two sides in the first direction, the first flange holding an end of the roll paper on the one side in the first direction, a second flange provided at an end of the rotation shaft on the other of the two sides in the first direction, the second flange holding an end of the roll paper on the other side in the first direction, and a positioning flange provided on the rotation shaft and located at a predetermined position on the one side in the first direction with respect to the first flange, and the support holder includes a position determiner including a recessed portion housing a portion of the positioning flange in a state where the roll paper holder is rotatably supported and also including a restriction portion partitioning the recessed portion and restricting the positioning flange from moving in the first direction.

An inkjet printer according to an example embodiment of the present invention includes the support holder supporting the roll paper holder such that the roll paper holder is detachable and rotatable, the roll paper holder holding the roll paper. With this configuration, the roll paper holder may be easily attached to the support holder. The support holder includes the position determiner including the recessed portion housing a portion of the positioning flange in a state where the roll paper holder is rotatably supported, and also including the restriction portion partitioning the recessed portion and restricting the positioning flange from moving in the first direction. The positioning flange partially housed in the recessed portion is restricted by the restriction portion from moving in the first direction. That is, the position of the positioning flange in the first direction is determined by the restriction portion, so that the position of the roll paper holder in the first direction with respect to the support holder is uniquely determined. This uniquely determines the position of the roll paper in the first direction, held by the roll paper holder, in the housing.

Example embodiments of the present invention provide inkjet printers each allowing a roll paper holder, holding a roll paper, to be positioned with respect to a support holder easily and to be attached to the support holder easily.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to an example embodiment of the present invention.

FIG. 2 is a front view of a printer according to an example embodiment of the present invention.

FIG. 3 is a front view of an inkjet head and a cutting head according to an example embodiment of the present invention.

FIG. 4 is a block diagram of a controller of a printer according to an example embodiment of the present invention.

FIG. 5 is a front view showing a configuration of a roll paper holder and the vicinity thereof according to an example embodiment of the present invention.

FIG. 6 is a perspective view showing a positioning flange and a position determiner according to an example embodiment of the present invention.

FIG. 7 is a perspective view showing a configuration of the position determiner and the vicinity thereof according to an example embodiment of the present invention.

FIG. 8 is a perspective view showing the positioning flange and the position determiner according to an example embodiment of the present invention.

FIG. 9 is a side view showing a state immediately before a rotation shaft is attached to a support according to an example embodiment of the present invention.

FIG. 10 is a side view showing a state where the rotation shaft is supported by the support according to an example embodiment of the present invention.

FIG. 11 is a cross-sectional view taken along line XI-XI in FIG. 7.

FIG. 12 is a cross-sectional view taken along line XII-XII in FIG. 7.

### DETAILED DESCRIPTION OF THE EXAMPLE EMBODIMENTS

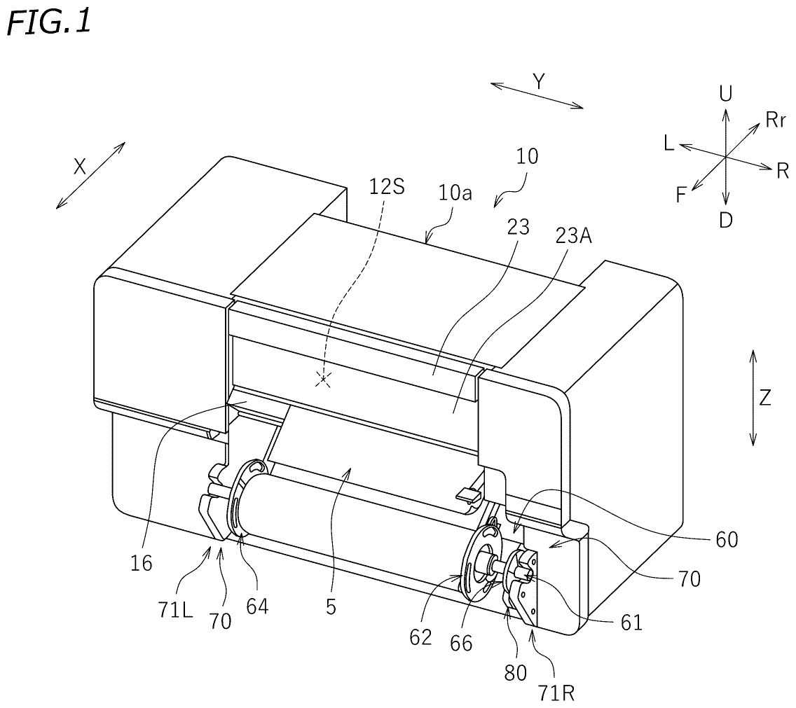

Hereinafter, example embodiments of an inkjet printer 10 (hereinafter, referred to as a “printer 10”) according to the present invention will be described with reference to the drawings. As shown in FIG. 1, the printer 10 according to the present example embodiment is a printer and cutter capable of performing printing and cutting on a roll paper 5. Example embodiments described herein are not intended to limit the present invention. Components and portions having the same functions will bear the same reference signs, and overlapping descriptions will be omitted or simplified when appropriate.

In the following description, the terms “left”, “right”, “up” and “down” will respectively refer to left, right, up and down seen from an operator facing a front surface of the printer 10. Where the operator is facing the printer 10, a direction from the printer 10 toward the operator will be referred to as “forward”, and a direction from the operator toward the printer 10 will be referred to as “rearward”. In the drawings, letters F, Rr, L, R, U and D respectively represent front, rear, left, right, up and down. In the drawings, letter Y represents a main scanning direction. In this example embodiment, the main scanning direction Y is a left-right direction. The main scanning direction Y is an example of first direction. In the drawings, letter X represents a sub scanning direction. The sub scanning direction X is a direction perpendicular to the main scanning direction Y as seen in a plan view. The sub scanning direction X is an example of second direction. In the drawings, letter Z represents an up-down direction. The up-down direction Z is a direction perpendicular to the main scanning direction Y as seen in a front view. It should be noted that the above-described directions are defined merely for the sake of convenience, and are not to be interpreted as limiting of example embodiments of the present invention in any way.

The roll paper 5 is a band-shaped recording medium wound into a cylindrical shape. The recording medium is, for example, a recording paper sheet. The recording medium is not limited to a recording paper sheet. The recording medium may be, for example, a sheet formed of a resin material such as polyvinyl chloride (PVC), polyester or the like, or a seal member including a mount and release paper stacked on the mount and having a pressure-sensitive adhesive material applied thereto. In this specification, the term “cutting” encompasses cutting the recording medium along the entirety of the thickness direction thereof (e.g., cutting both of the mount and the release paper of the seal member) and cutting the recording medium along a portion of the thickness direction thereof (e.g., cutting only the release paper of the seal member without cutting the mount).

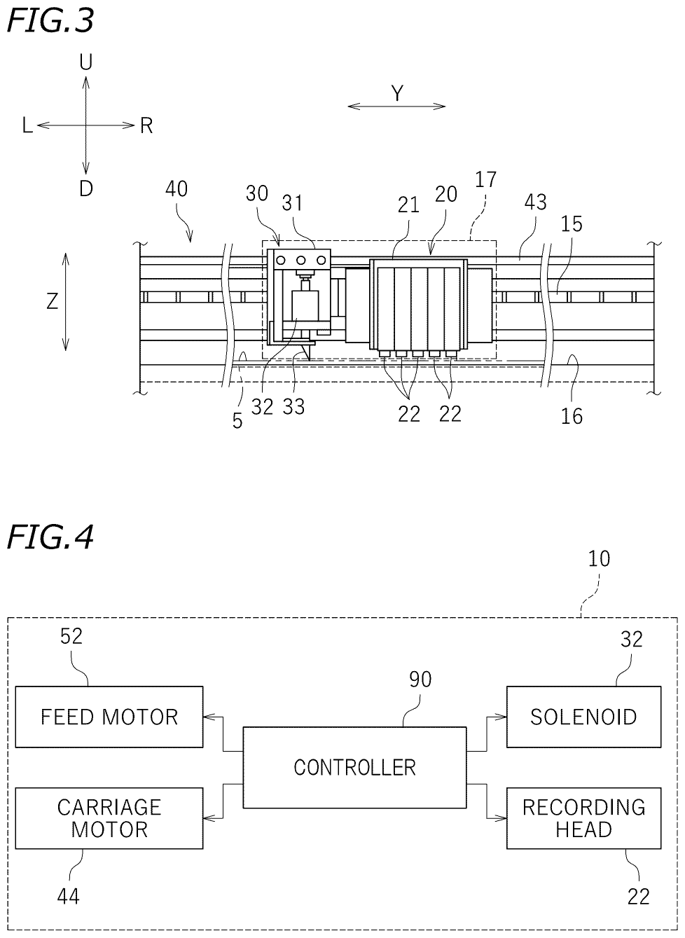

As shown in FIG. 1, the printer 10 includes a printer main body 10a that is box-shaped and a front cover 23. The printer main body 10a is an example of housing. The printer main body 10a has an inner space 12S formed therein. In this example embodiment, the front cover 23 is supported by the printer main body 10a so as to be rotatable about a top end thereof as an axis. The front cover 23 is rotated upward, and as a result, the inner space 12S of the printer main body 10a and an outer space outside the printer main body 10a are communicated with each other. The inner space 12S is a space in which printing is performed on the roll paper 5 by an inkjet head 20 (see FIG. 3) described below or the roll paper 5 is cut by the cutting head 30 (see FIG. 3). The inner space 12S is covered with the front cover 23 as described above, and therefore, dust or the like in the outer space does not easily enter the inner space 12S during printing or the like.

As shown in FIG. 1, a window 23A is provided in a bottom portion of the front cover 23. The window 23A is formed of, for example, a transparent acrylic plate. The window 23A is treated such that light (e.g., ultraviolet light) in the outer space does not reach the inner space 12S. A user may visually recognize the inside of the printer main body 12a through the window 23A.

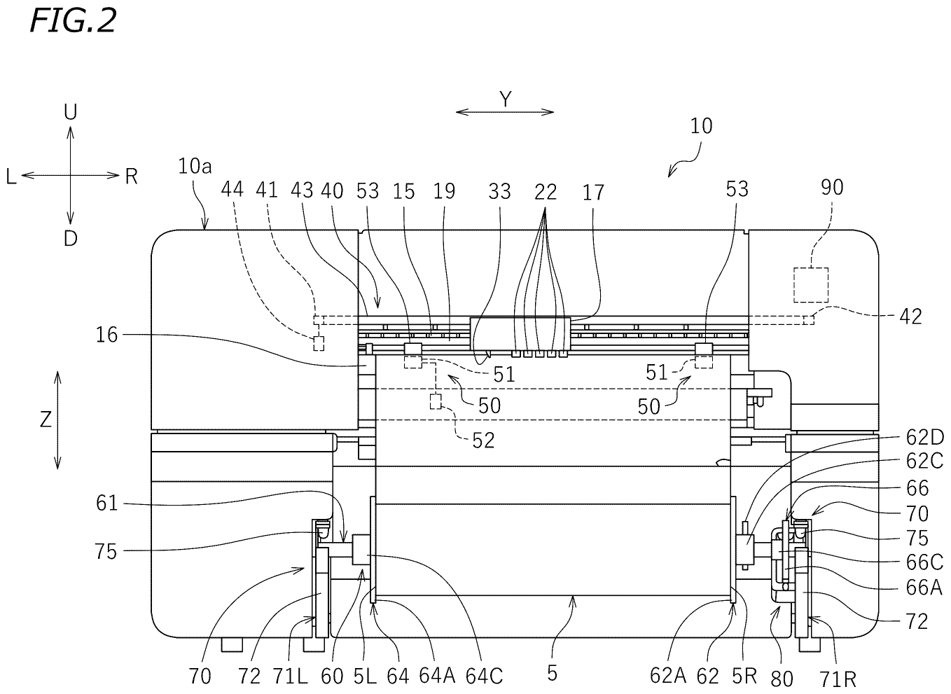

Now, an internal configuration of the printer 10 will be described. As shown in FIG. 2, the printer 10 includes a guide rail 15, a platen 16, on which the roll paper 5 is to be placed, a main body frame 19, a carriage 17, the inkjet head 20 (see FIG. 3), the cutting head 30 (see FIG. 3), a head mover 40, a conveyor 50, a roll paper holder 60, a support holder 70, and a controller 90.

As shown in FIG. 2, the platen 16 supports the roll paper 5 while printing is performed on the roll paper 5 or while the roll paper 5 is cut. The roll paper 5 is placed on the platen 16. Printing and cutting on the roll paper 5 are performed on the platen 16. The platen 16 extends in the main scanning direction Y and the sub scanning direction X. As shown in FIG. 1, an area of the platen 16 including a front end thereof protrudes outside from the inner space 12S.

As shown in FIG. 2, the guide rail 15 extending in the main scanning direction Y is located above the platen 16. The guide rail 15 is secured to the main body frame 19.

As shown in FIG. 2, the carriage 17 is supported by the guide rail 15. The carriage 17 is slidable in the main scanning direction Y. As shown in FIG. 3, the inkjet head 20 and the cutting head 20 are mounted on the carriage 17. Therefore, when the carriage 17 moves in the main scanning direction Y, the inkjet head 20 and the cutting head 20 move in the main scanning direction Y. In this example embodiment, the cutting head 30 is located to the left of the inkjet head 20.

As shown in FIG. 3, the inkjet head 20 is provided in the printer main body 10a. The inkjet head 20 performs printing on the roll paper 5 placed on the platen 16. The inkjet head 20 discharges ink toward the roll paper 5. The inkjet head 20 is movable in the main scanning direction Y. The inkjet head 20 includes an ink carriage 21 and recording heads 22 including a plurality of nozzles (not shown) from which ink is discharged. In this example embodiment, five recording heads 22 are supported by the ink carriage 21, for example. The five recording heads 22 respectively discharge ink of five different colors, for example, yellow ink, magenta ink, cyan ink, black ink and white ink. The number of the recording heads 22 is not limited to five. There is no limitation on the colors of the ink to be discharged by the recording heads 22. The ink carriage 21 is supported by the carriage 17.

The cutting head 30 cuts the roll paper 5 placed on the platen 16. The cutting head 30 is movable in the main scanning direction Y. As shown in FIG. 3, the cutting head 30 includes a cutting carriage 31, a solenoid 32, and a cutter 33. The cutter 33 is attached to the cutting carriage 31 via the solenoid 32. The solenoid 32 is controlled by the controller 90 (see FIG. 2). When the solenoid 32 is turned ON/OFF, the cutter 33 moves in the up-down direction Z to contact the roll paper 5 or to be separated away from the roll paper 5. The cutting carriage 31 is supported by the carriage 17.

The head mover 40 moves the carriage 17 (i.e., the inkjet head 20 and the cutting head 30) in the main scanning direction Y with respect to the roll paper 5 placed on the platen 16. The head mover 40 moves the carriage 17 in the main scanning direction Y. There is no specific limitation on the configuration of the head mover 40. As shown in FIG. 2, the head mover 40 includes a left pulley 41, a right pulley 42, a belt 43, and a carriage motor 44 (see also FIG. 4). The left pulley 41 is provided at a left end of the guide rail 15. The right pulley 42 is provided at a right end of the guide rail 15. The belt 43 is wound along the left pulley 41 and the right pulley 42. The belt 43 is secured to a top rear portion of the carriage 17. The carriage motor 44 is connected with the left pulley 41. Alternatively, the carriage motor 44 may be connected with the right pulley 42. In this example embodiment, the carriage motor 44 is driven to rotate the left pulley 41, and as a result, the belt 43 runs between the left pulley 41 and the right pulley 42. This moves the carriage 17 in the main scanning direction Y. The carriage motor 44 is controlled by the controller 90.

As shown in FIG. 2, the conveyor 50 conveys the roll paper 5 placed on the platen 16 in the sub scanning direction X with respect to the carriage 17 (i.e., the inkjet head 20 and the cutting head 30). In this example embodiment, the conveyor 50 conveys the roll paper 5 placed on the platen 16 (i.e., the roll paper 5 held by the roll paper holder 60) in the sub scanning direction X. The conveyor 50 includes grit rollers 51, a feed motor 52 (see also FIG. 4), and pinch rollers 53.

The grit rollers 51 are provided on the platen 16. The grit rollers 51 are each embedded in the platen 16 such that a top portion thereof is exposed outside. The grit rollers 51 are aligned in the main scanning direction Y. There is no specific limitation on the number of the grit rollers 51. The grit rollers 51 are located below the pinch rollers 53. The grit rollers 51 sandwich the roll paper 5 together with the pinch rollers 53. The grit rollers 51 are connected with the feed motor 52.

The pinch rollers 53 are located above the grit rollers 53 so as to face the grit rollers 53 in the up-down direction Z. The pinch rollers 53 are formed of, for example, rubber. There is no specific limitation on the material of the pinch rollers 53. The pinch rollers 53 are provided in the same number as that of the grit rollers 51. There is no specific limitation on the number of the pinch rollers 53.

The feed motor 52 is controlled by the controller 90. When the feed roller 52 is driven to rotate the grit rollers 51 in a state where the roll paper 5 is sandwiched between the grit rollers 51 and the pinch rollers 53, the roll paper 5 is conveyed in the sub scanning direction X. In this example embodiment, the roll paper 5 is conveyed from the front to the rear (i.e., rearward) or from the rear to the front (i.e., forward) in a state of being sandwiched between the grit rollers 51 and the pinch rollers 53.

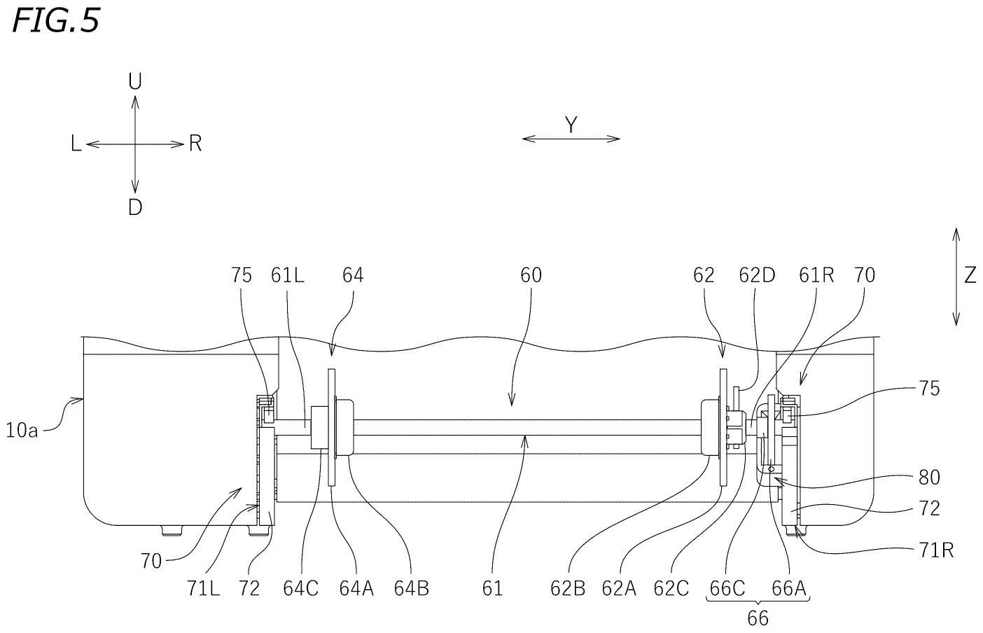

As shown in FIG. 2, the roll paper holder 60 holds the roll paper 5. The roll paper holder 60 is located in a bottom portion of the printer main body 10a. The roll paper holder 60 is located below the platen 16. The roll paper holder 60 is located to the front of the platen 16. The roll paper holder 60 is located to the front of the inkjet head 20 (located on the front side with respect to the inkjet head 20). The roll paper 5 held by the roll paper holder 60 passes through the printer main body 10a (passes below the platen 16) and is pulled out from the rear to the front of the printer 10. The roll paper 5 thus pulled out is placed on the platen 16. As shown in FIG. 5, the roll paper holder 60 includes a rotation shaft 61, a first flange 62, a second flange 64, and a positioning flange 66. In FIG. 5, the roll paper holder 60 does not hold the roll paper 5.

As shown in FIG. 5, the rotation shaft 61 extends in the main scanning direction Y. The rotation shaft 61 is supported by the support holder 70. The rotation shaft 61 is longer than the platen 16 in the main scanning direction Y.

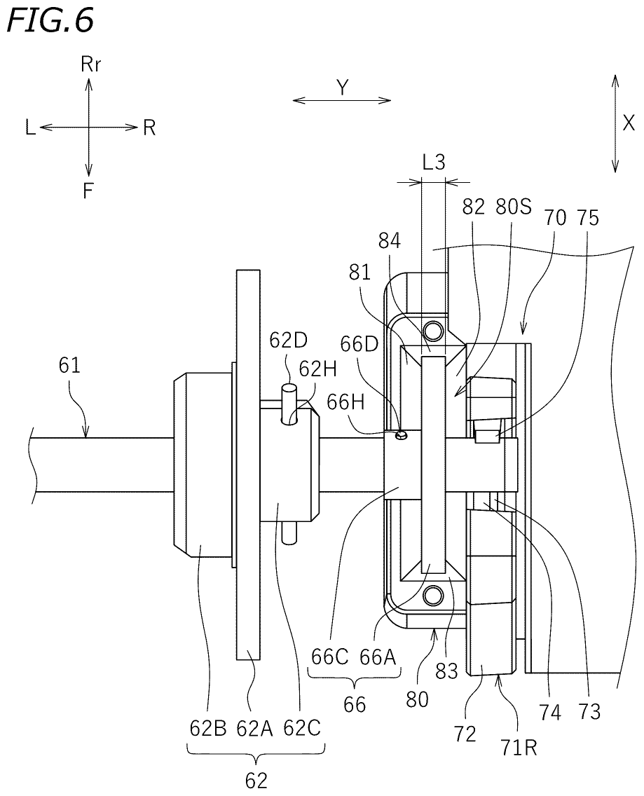

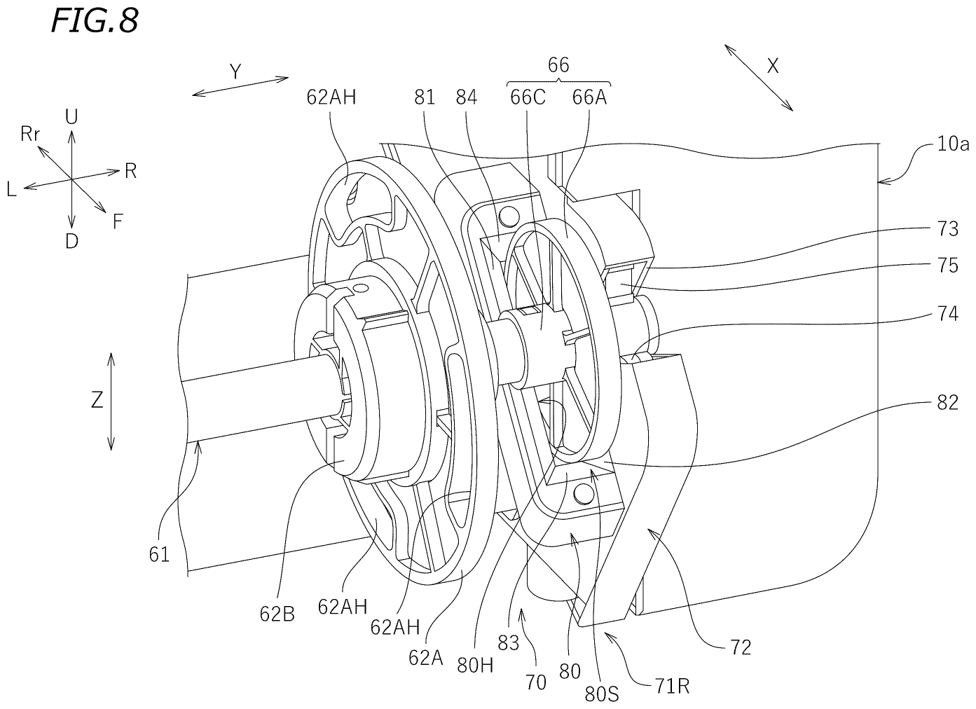

As shown in FIG. 5, the first flange 62 is provided at a right end 61R of the rotation shaft 61. The first flange 62 is secured to the rotation shaft 61. The first flange 62 holds a right end 5R (see FIG. 2) of the roll paper 5. The first flange 62 includes a first disc portion 62A having a disc shape, a first holding portion 62B located to the left of the first disc portion 62A and having a cylindrical shape, and a first cylindrical portion 62C located to the right of the first disc portion 62A and having a cylindrical shape. The first disc portion 62A, the first holding portion 62B and the first cylindrical portion 62C are integrally formed with each other. The first disc portion 62A and the first holding portion 62B hold the right end 5R of the roll paper 5. The roll paper 5 is inserted into the first holding portion 62B. The first disc portion 62A restricts the roll paper 5 from moving rightward. The first cylindrical portion 62C has an insertion hole 62H (see FIG. 6) formed therein, through which a securing pin 62D is inserted. The securing pin 62D secures the first cylindrical portion 62C to the rotation shaft 61. The first holding portion 62B has a diameter shorter than a diameter of the first disc portion 62A. The diameter of the first holding portion 62B is longer than a diameter of the first cylindrical portion 62C. As shown in FIG. 8, the first disc portion 62A has through-holes 62AH, extending therethrough in the main scanning direction Y, formed therein. In this example embodiment, three through-holes 62AH are formed along a circumferential direction of the first disc portion 62A, for example. The through-holes 62AH are aligned at an equal or substantially equal interval. The through-holes 62AH each have an elliptical or substantially elliptical shape extending in the circumferential direction of the first disc portion 62A.

As shown in FIG. 5, the second flange 64 is provided at a left end 61L of the rotation shaft 61. The second flange 64 is movable in the main scanning direction Y along the rotation shaft 61. The second flange 64 is configured to be movable in the main scanning direction Y to correspond to the width of the roll paper 5. Therefore, the second flange 64 is not secured to the rotation shaft 61 before the roll paper 5 is set. The second flange 64 holds a left end 5L (see FIG. 2) of the roll paper 5. The second flange 64 includes a second disc portion 64A having a disc shape, a second holding portion 64B located to the right of the second disc portion 64A and having a cylindrical shape, and a second cylindrical portion 64C located to the left of the second disc portion 64A and having a cylindrical shape. The second disc portion 64A, the second holding portion 64B and the second cylindrical portion 64C are integrally formed with each other. The second disc portion 64A and the second holding portion 64B hold the left end 5L of the roll paper 5. The roll paper 5 is inserted into the second holding portion 64B. The second disc portion 64A restricts the roll paper 5 from moving leftward. The second holding portion 64B has a diameter shorter than a diameter of the second disc portion 64A. The diameter of the second holding portion 64B is longer than a diameter of the second cylindrical portion 64C. The diameter of the second disc portion 64A is equal to the diameter of the first disc portion 62A. The diameter of the second holding portion 64B is equal to the diameter of the first holding portion 62B. Although not shown, the second disc portion 64A has through-holes substantially the same as those of the first disc portion 62A formed therein. The second flange 64 is secured to the rotation shaft 61 by a locking mechanism (not shown) after the roll paper 5 is set.

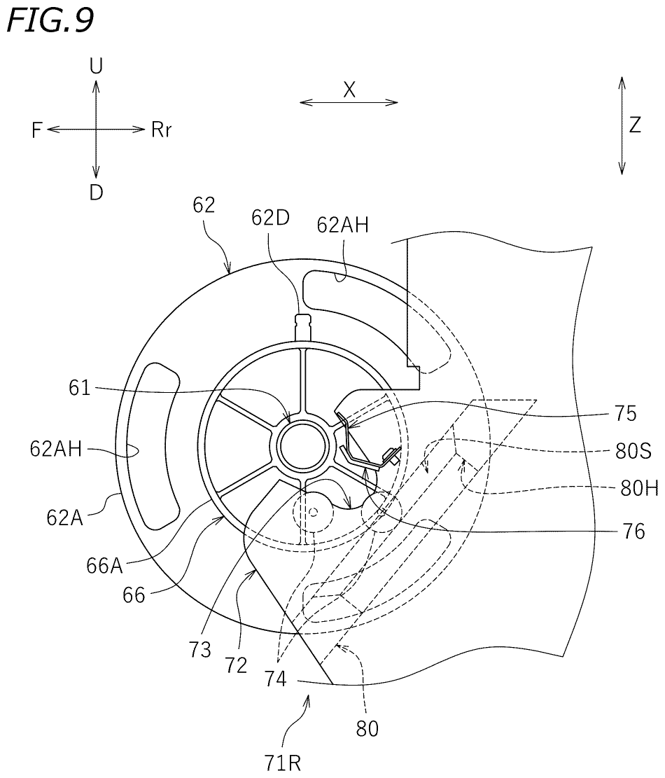

As shown in FIG. 5, the positioning flange 66 is provided on the rotation shaft 61. The positioning flange 66 is, for example, secured to the rotation shaft 61. The positioning flange 66 is located at a predetermined position to the right of the first flange 62. The relative positions of the positioning flange 66 and the first flange 62 in the main scanning direction Y do not change. The positioning flange 66 includes a positioning disc portion 66A having a disc shape, and a cylindrical portion 66C located to the left of the positioning disc portion 66A and having a cylindrical shape. The positioning disc portion 66A and the cylindrical portion 66C are integrally formed with each other. The positioning flange 66 is formed of a resin material. The positioning disc portion 66A is housed in an insertion hole 80H (described below) of the support holder 70. The positioning disc portion 66A has a disc shape, and therefore, may be inserted, from above, into the insertion hole 80H of a position determiner 80 regardless of the position of the roll paper holder 60 in a rotation direction thereof. In this manner, the work of attaching the roll paper holder 60 to the support holder 70 may be performed easily. As shown in FIG. 6, the cylindrical portion 66C has an insertion hole 66H formed therein, into which a securing pin 66D is inserted. The securing pin 66D secures the cylindrical portion 66C to the rotation shaft 61. The positioning disc portion 66A has a diameter greater than a diameter of the cylindrical portion 66C. The diameter of the first disc portion 62A is longer than the diameter of the positioning disc portion 66A. As shown in FIG. 9, the positioning disc portion 66A does not overlap any of the through-holes 62AH of the first disc portion 62A as seen in the main scanning direction Y (in this example embodiment, as seen leftward from the right).

As shown in FIG. 2, the support holder 70 supports the roll paper holder 60 such that the roll paper holder 60 is detachable and rotatable. The support holder 70 is provided in the printer main body 10a. The support holder 70 is located below the platen 16. The support holder 70 is located to the front of the platen 16. As shown in FIG. 5, the support holder 70 includes a left support 71L, a right support 71R, and the position determiner 80. The left support 71L and the right support 71R are each an example of support. The left support 71L and the right support 71R have the same configuration as each other except for being located bilaterally symmetrically to each other. Thus, the right support 71R will be described, hereinafter.

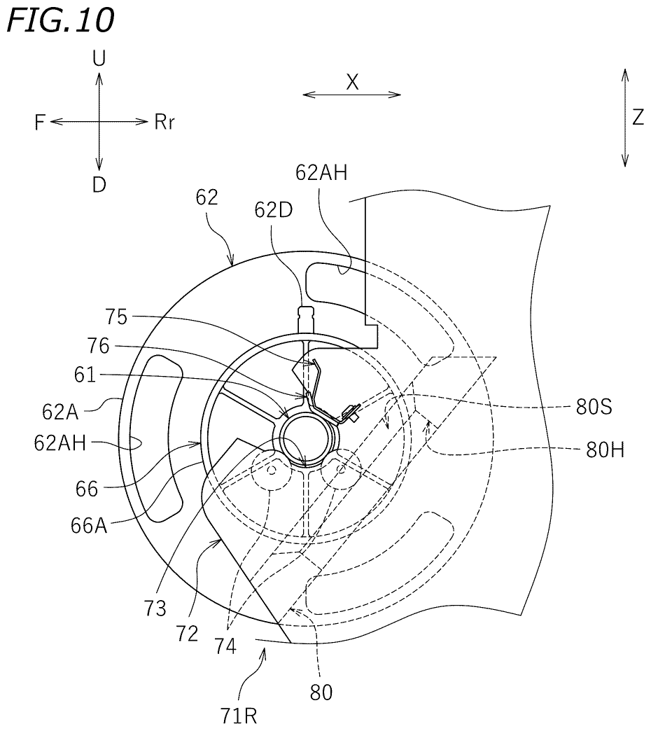

As shown in FIG. 2, the right support 71R supports the rotation shaft 61 such that the rotation shaft 61 is detachable and rotatable. The right support 71R is provided in the printer main body 10a. The right support 71R is provided below the platen 16. The right support 71R is provided to the front of the platen 16. The right support 71R is provided to the right of the platen 16. As shown in FIG. 9 and FIG. 10, the right support 71R includes a main body 72, a recessed portion 73 formed in the main body 72, a pair of rollers 74 provided on the main body 72, and a spring 75 provided on the main body 73. The main body 72 is provided in the printer main body 10a. The main body 72 supports the rotation shaft 61. The rotation shaft 61 is located in the recessed portion 73. The recessed portion 73 is recessed obliquely rearward and downward. Therefore, the rotation shaft 61 may be easily located in the recessed portion 73 from the front of the recessed portion 73. The rollers 74 are rotatably provided on the main body 72. A portion of each of the rollers 74 is located in the recessed portion 73 as seen in the main scanning direction Y. The rotation shaft 61 is placed on the rollers 74. The rollers 74 support the rotation shaft 61 such that the rotation shaft 61 is rotatable. The pair of rollers 74 are aligned in the sub scanning direction X. The rollers 74 are formed of, for example, rubber. The spring 75 is provided on the main body 72. A portion of the spring 75 is located in the recessed portion 73 as seen in the main scanning direction Y. The spring 75 is located above the rollers 74. The spring 75 presses the rotation shaft 61, placed on the rollers 74, to the rollers 74. A cushioning member 76 is attached to a portion of the spring 75 that presses the rotation shaft 61.

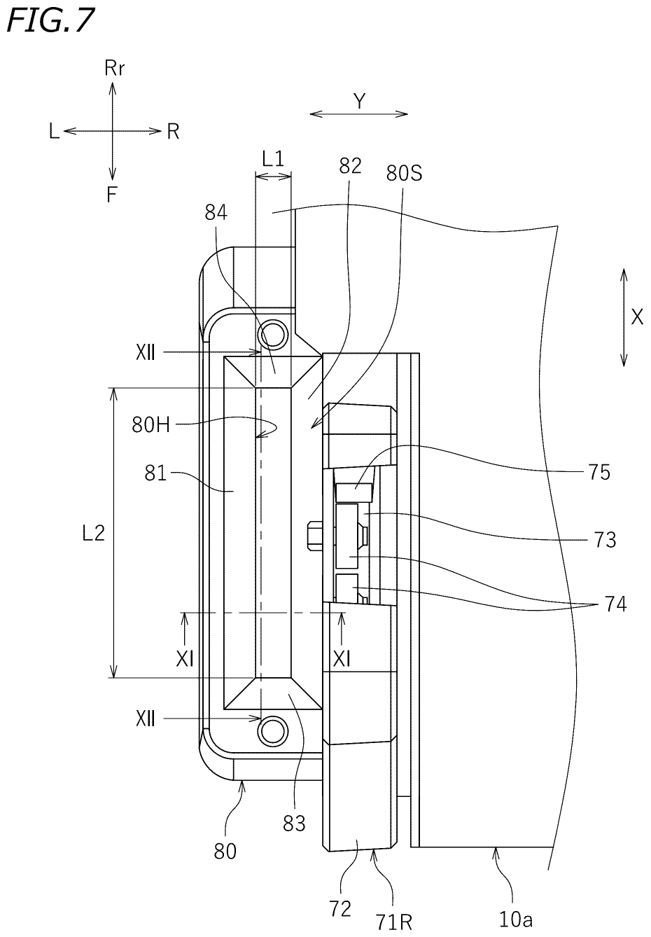

As shown in FIG. 7, the position determiner 80 is box-shaped. The position determiner 80 is formed of a resin material. As shown in FIG. 8, the position determiner 80 is provided on the right support 71R. The position determiner 80 is located to the left of the right support 71R. Alternatively, the position determiner 80 may be located to the right of the right support 71R. The position determiner 80 includes the insertion hole 80H and a restriction wall 80S partitioning the insertion hole 80H. The insertion hole 80H is an example of recessed portion. The restriction wall 80S is an example of restriction portion. The position determiner 80 determines the position of the positioning flange 66 in the main scanning direction Y. That is, the positioning flange 66 housed in the insertion hole 80H is restricted by the restriction wall 80S from moving in the main scanning direction Y as described below, and as a result, the position of the roll paper holder 60 in the main scanning direction Y with respect to the support holder 70 (i.e., the position of the roll paper 5 with respect to the printer main body 10a) is uniquely defined.

As shown in FIG. 7, the insertion hole 80H has a length L2 in the sub scanning direction X longer than a length L1 in the main scanning direction Y. The length L1 of the insertion hole 80H in the main scanning direction Y is sightly longer than a length L3 (see FIG. 6) of the positioning disc portion 66A in the main scanning direction Y. The insertion hole 80H houses a portion of the positioning flange 66 (more specifically, a portion of the positioning disc portion 66A) in a state where the roll paper holder 60 is rotatably supported. The insertion hole 80H houses a portion of the positioning flange 66 in a state where the rotation shaft 61 is supported by the right support 71R.

The restriction wall 80S restricts the positioning flange 66 from moving in the main scanning direction Y. As shown in FIG. 7, the restriction wall 80S includes a first side wall 81, a second side wall 82, a third side wall 83 and a fourth side wall 84. The first side wall 81, the second side wall 82, the third side wall 83 and the fourth side wall 84 partition the insertion hole 80H.

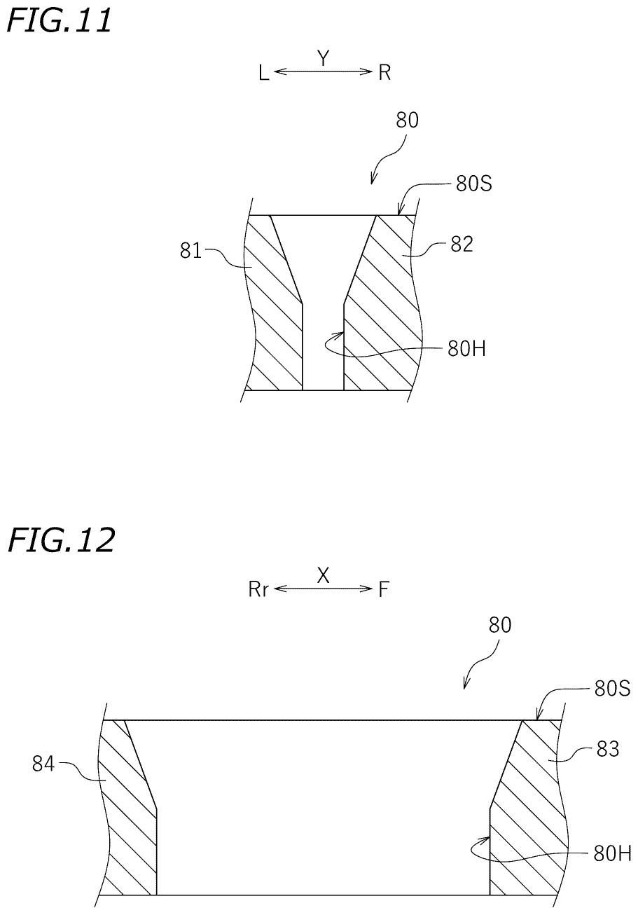

As shown in FIG. 7, the first side wall 81 and the second side wall 82 extend in the sub scanning direction X. The first side wall 81 and the second side wall 82 extend in the up-down direction Z. The second side wall 82 is located to the right of the first side wall 81. The second side wall 82 faces the first side wall 81. As shown in FIG. 6, in a state where the rotation shaft 61 is attached to the right support 71R, the positioning flange 66 (more specifically, the positioning disc portion 66A) is located between the first side wall 81 and the second side wall 82. As shown in FIG. 11, the first side wall 81 inclines such that a distance between the first side wall 81 and the second side wall 82 decreases as the first side wall 81 extends from the left to the right. As shown in FIG. 11, the second side wall 82 inclines such that the distance between the second side wall 82 and the first side wall 81 decreases as the second side wall 82 extends from the right to the left. The first side wall 81 and the second side wall 82 incline at the same angle as each other in this example embodiment, but may incline at different angles from each other.

As shown in FIG. 7, the third side wall 83 and the fourth side wall 84 extend in the main scanning direction Y. The third side wall 83 and the fourth side wall 84 extend in the up-down direction Z. The third side wall 83 is connected with a front end of the first side wall 81 and a front end of the second side wall 82. The fourth side wall 84 is located to the rear of the third side wall 83. The fourth side wall 84 faces the third side wall 83. The fourth side wall 84 is connected with a rear end of the first side wall 81 and a rear end of the second side wall 82. As shown in FIG. 6, in a state where the rotation shaft 61 is attached to the right support 71R, the positioning flange 66 (more specifically, the positioning disc portion 66A) is located between the third side wall 83 and the fourth side wall 84. As shown in FIG. 12, the third side wall 83 inclines such that a distance between the third side wall 83 and the fourth side wall 84 decreases as the third side wall 83 extends from the front to the rear. The fourth side wall 84 inclines such that the distance between the fourth side wall 84 and the third side wall 83 decreases as the fourth side wall 84 extends from the rear to the front. The third side wall 83 and the fourth side wall 84 incline at the same angle as each other in this example embodiment, but may incline at different angles from each other.

As shown in FIG. 4, the controller 90 is configured or programmed to control the printing performed on the roll paper 5 and the cutting performed on the roll paper 5. There is no specific limitation on the configuration of the controller 90. The controller 90 is, for example, a microcomputer. There is no specific limitation on the hardware configuration of the microcomputer. The microcomputer includes, for example, an I/F, a CPU, a ROM, a RAM, and a storage device. As shown in FIG. 2, the controller 90 is provided inside the printer main body 10a. It should be noted that the controller 90 does not need to be provided inside the printer main body 10a. For example, the controller 90 may be a computer or the like installed outside the printer main body 10a. In this case, the controller 90 is communicably connected with the printer main body 10a in a wired or a wireless manner.

As shown in FIG. 4, the controller 90 controls the driving of the carriage motor 44. By such control, the controller 90 controls the rotation of the right pulley 42 and the running of the belt 43 (see FIG. 2). By such control, the controller 90 controls the movement of the carriage 17 in the main scanning direction Y. The controller 90 controls the timing at which the recording heads 22 discharge ink and the amounts of the ink to be discharged. The controller 90 controls the solenoid 32 to control the movement of the cutter 33 in the up-down direction Z. The controller 90 controls the driving of the feed motor 52 to control the rotation of the grit rollers 51, and as a result, the roll paper 5 is conveyed in the sub scanning direction X.

The configuration of the printer 10 is described above. Now, a procedure of attaching the roll paper holder 60 to the support holder 70 will be described.

First, the roll paper holder 60 is caused to hold the roll paper 5. Specifically, in a state where the second flange 64 is detached from the rotation shaft 61, the rotation shaft 61 is inserted into the roll paper 5, and the first flange 62 is caused to hold the right end 5R of the roll paper 5. At this point, the roll paper 5 is inserted into the first holding portion 62B. Then, the second flange 64 is attached to the rotation shaft 61, and the second flange 64 is caused to hold the left end 5L of the roll paper 5. At this point, the roll paper 5 is inserted into the second holding portion 64B. Next, the support holder 70 is caused to support the roll paper holder 60 (the roll paper holder 60 is attached to the support holder 70). Specifically, the rotation shaft 61 of the roll paper holder 60 is attached to the left support 71L and the right support 71R. In this example embodiment, when the rotation shaft 61 is to be attached to the left support 71L and the right support 71R, the positioning flange 66 is housed in the insertion hole 80H of the position determiner 80. With this arrangement, the position of the roll paper holder 60 in the main scanning direction Y with respect to the support holder 70 is uniquely determined, and the roll paper holder 60 is easily attached to the support holder 70. As shown in FIG. 9, when the rotation shaft 61 is to be attached to the left support 71L and the right support 71R, a portion of the positioning flange 66 (in this example embodiment, the positioning disc portion 66A) contacts the restriction wall 80S before the rotation shaft 61 contacts the left support 71L and the right support 71R (more specifically, the main body 72, the rollers 74 and the spring 75). More specifically, when the rotation shaft 61 is to be attached to the left support 71L and the right support 71R, the positioning disc portion 66A contacts either one of the first side wall 81, the second side wall 82, the third side wall 83 and the fourth side wall 84 of the restriction wall 80S. The first side wall 81, the second side wall 82, the third side wall 83 and the fourth side wall 84 incline toward the insertion hole 80H, and therefore, the positioning disc portion 66A is easily guided to the insertion hole 80H. In this manner, the positioning disc portion 66A is housed in the insertion hole 80H. At this point, as shown in FIG. 10, the rotation shaft 61 is placed on the pair of rollers 74, and is pressed to the rollers 74 by the spring 75 via the cushioning member 76. This prevents a situation where the rotation shaft 61 comes off.

As described above, the printer 10 according to this example embodiment includes the support holder 70 to support the roll paper holder 60 such that the roll paper holder 60 is detachable and rotatable, the roll paper holder 60 holding the roll paper 5. With this configuration, the roll paper holder 60 may be easily attached to the support holder 70. The support holder 70 includes the position determiner 80 including the insertion hole 80H housing a portion of the positioning flange 66 in a state where the roll paper holder 60 is rotatably supported, and also including the restriction wall 80S partitioning the insertion hole 80H and restricting the positioning flange 66 from moving in the main scanning direction Y. The positioning flange 66 partially housed in the insertion hole 80H is restricted by the restriction wall 80S (specifically the first side wall 81 and the second side wall 82) from moving in the main scanning direction Y. That is, the position of the positioning flange 66 in the main scanning direction Y is determined by the restriction wall 80S, so that the position of the roll paper holder 60 in the main scanning direction Y with respect to the support holder 70 is uniquely determined. This uniquely determines the position of the roll paper 5 in the main scanning direction Y, held by the roll paper holder 60, in the printer main body 10a.

In the printer 10 according to this example embodiment, when the rotation shaft 61 is to be attached to the left support 71L and the right support 71R, a portion of the positioning flange 66 contacts the restriction wall 80S before the rotation shaft 61 contacts the left support 71L and the right support 71R. According to this example embodiment, the portion of the positioning flange 66 first contacts the restriction wall 80S, so that the positioning flange 66 is guided by the restriction wall 80S to be housed at a predetermined position in the insertion hole 80H.

In the printer 10 according to this example embodiment, the first side wall 81 of the restriction wall 80S inclines such that the distance between the first side wall 81 and the second side wall 82 decreases as the first side wall 81 extends from the left to the right, and the second side wall 82 inclines such that the distance between the second side wall 82 and the first side wall 81 decreases as the second side wall 82 extends from the right to the left. According to this example embodiment, when the rotation shaft 61 is to be attached to the left support 71L and the right support 71R, even if the position of the positioning flange 66 with respect to the insertion hole 80H is slightly shifted in the main scanning direction Y, the positioning flange 66 is guided by the first side wall 81 or the second side wall 82 to be housed at a predetermined position in the insertion hole 80H.

In the printer 10 according to this example embodiment, the third side wall 83 of the restriction wall 80S inclines such that the distance between the third side wall 83 and the fourth side wall 84 decreases as the third side wall 83 extends from the front to the rear, and the fourth side wall 84 inclines such that the distance between the fourth side wall 84 and the third side wall 83 decreases as the fourth side wall 84 extends from the rear to the front. According to this example embodiment, when the rotation shaft 61 is to be attached to the left support 71L and the right support 71R, even if the position of the positioning flange 66 with respect to the insertion hole 80H is slightly shifted in the sub scanning direction X, the positioning flange 66 is guided by the third side wall 83 or the fourth side wall 84 to be housed at a predetermined position in the insertion hole 80H.

In the printer 10 according to this example embodiment, the first flange 62 includes the first disc portion 62A having a disc shape, the positioning flange 66 includes the positioning disc portion 66A having a disc shape, and the diameter of the first disc portion 62A is longer than the diameter of the positioning disc portion 66A. According to this example embodiment, the position determiner 80 and the positioning flange 66 may be located in a compact manner, and this may reduce or prevent enlargement of the printer 10.

In the printer 10 according to this example embodiment, the first disc portion 62A has the through-holes 62AH, extending therethrough in the main scanning direction Y, formed therein.

As seen in the main scanning direction Y, the positioning disc portion 66A and the through-holes 62AH do not overlap each other. According to this example embodiment, when, for example, the user inserts his/her fingers into the through-holes 62AH to rotate the roll paper holder 60, the positioning disc portion 66A does not disturb the work of rotating the roll paper holder 60.

In the printer 10 according to this example embodiment, the through-holes 60AH each have an elliptical shape extending in the circumferential direction of the first disc portion 62A. According to this example embodiment, when, for example, the user inserts his/her fingers into the through-holes 62AH to rotate the roll paper holder 60, the user may grasp the first disc portion 62A more certainly.

In the printer 10 according to this example embodiment, the roll paper holder 60 is located to the front of the inkjet head 20. The user usually works while standing at a position to the front of the inkjet head 20. The roll paper holder 60 is located to the front of the inkjet head 20, and therefore, the user may attach or detach the roll paper holder 60 with no need to move from the position where the he/she is standing.

In the printer 10 according to this example embodiment, the left support 71L and the right support 71R each include the main body 72, the pair of rollers 74 provided on the main body 72 and supporting the rotation shaft 61 such that the rotation shaft 61 is rotatable, and the spring 75 pressing the rotation shaft 61 to the rollers 74. According to this example embodiment, a situation where the rotation shaft 61 attached to the left support 71L and the right support 71R comes off may be prevented.

In the printer 10 according to this example embodiment, the positioning flange 66 and the position determiner 80 are formed of a resin material. According to this example embodiment, even if the positioning flange 66 slides against the position determiner 80 as a result of the rotation of the roll paper holder 60, abrasion of the positioning flange 66 and the position determiner 80 may be reduced or prevented. In addition, an increase in the weight of the printer 10 may be reduced or prevented.

Example embodiments of the present invention are described above. The above-described example embodiments are merely examples, and the present invention may be carried out in any of various other example embodiments.

In the above-described example embodiments, the first flange 62 is secured at the right end 61R of the rotation shaft 61 whereas the second flange 64 is movable in the main scanning direction Y. The present invention is not limited to this. For example, the first flange 62 may be movable in the main scanning direction Y whereas the second flange 64 may be secured to the left end 61L of the rotation shaft 61. In this case, the positioning flange 66 is secured to a position to the left of the second flange 64, and the position determiner 80 is provided on the left support 71L. Also in this case, the position determiner 80 is located to the right of the left support 71L.

In the above-described example embodiments, the position determiner 80 has the insertion hole 80H, extending through the restriction wall 80S as an example of recessed portion, formed therein. The present invention is not limited to this. For example, the position determiner 80 may include a recessed groove, as an example of recessed portion, formed in the restriction wall 80S.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer, comprising:
a housing;
an inkjet head provided in the housing and movable in a first direction to discharge ink toward a roll paper;
a roll paper holder to hold the roll paper;
a support holder provided in the housing to support the roll paper holder such that the roll paper holder is detachable and rotatable; and
a conveyor to convey the roll paper, held by the roll paper holder, in a second direction perpendicular to the first direction as seen in a plan view; wherein
the roll paper holder includes:
a rotation shaft extending in the first direction;
a first flange secured to an end of the rotation shaft on one of two sides in the first direction, the first flange holding an end of the roll paper on the one side in the first direction;
a second flange provided at an end of the rotation shaft on the other of the two sides in the first direction, the second flange holding an end of the roll paper on the other side in the first direction; and
a positioning flange provided on the rotation shaft and located at a predetermined position on the one side in the first direction with respect to the first flange; and
the support holder includes a position determiner including a recessed portion housing a portion of the positioning flange in a state where the roll paper holder is rotatably supported and also including a restriction portion partitioning the recessed portion and restricting the positioning flange from moving in the first direction.

2. The inkjet printer according to claim 1, wherein
the support holder includes a support supporting the rotation shaft such that the rotation shaft is detachable and rotatable; and
when the rotation shaft is to be attached to the support, a portion of the positioning flange contacts the restriction portion before the rotation shaft contacts the support.

3. The inkjet printer according to claim 2, wherein:
the restriction portion includes:
a first side wall extending in the second direction; and
a second side wall extending in the second direction, located on the one side in the first direction with respect to the first side wall, and facing the first side wall;
the positioning flange is located between the first side wall and the second side wall in a state where the rotation shaft is attached to the support;
the first side wall inclines such that a distance between the first side wall and the second side wall decreases as the first side wall extends from the other side toward the one side in the first direction.

4. The inkjet printer according to claim 3, wherein:
the second side wall inclines such that the distance between the second side wall and the first side wall decreases as the second side wall extends from the one side toward the other side in the first direction.

5. The inkjet printer according to claim 3, wherein
the restriction portion includes:
a third side wall extending in the first direction; and
a fourth side wall extending in the first direction, located on one of two sides in the second direction with respect to the third side wall, and facing the third side wall;
the positioning flange is located between the third side wall and the fourth side wall in a state where the rotation shaft is attached to the support;
the third side wall inclines such that a distance between the third side wall and the fourth side wall decreases as the third side wall extends from the other of the two sides toward the one side in the second direction.

6. The inkjet printer according to claim 5, wherein:
the fourth side wall inclines such that the distance between the fourth side wall and the third side wall decreases as the fourth side wall extends from the one side toward the other side in the second direction.

7. The inkjet printer according to claim 2, wherein the support includes a main body, a pair of rollers provided on the main body and supporting the rotation shaft such that the rotation shaft is rotatable, and a spring pressing the rotation shaft to the pair of rollers.

8. The inkjet printer according to claim 1, wherein
the first flange includes a first disc portion having a disc shape;
the positioning flange includes a positioning disc portion having a disc shape; and
the first disc portion has a diameter greater than a diameter of the positioning disc portion.

9. The inkjet printer according to claim 8, wherein
the first disc portion has a through-hole extending therethrough in the first direction, formed therein; and
as seen in the first direction, the positioning disc portion and the through-hole do not overlap each other.

10. The inkjet printer according to claim 9, wherein the through-hole has an elliptical or substantially elliptical shape extending in a circumferential direction of the first disc portion.

11. The inkjet printer according to claim 1, wherein where the one side in the second direction is a rear side and the other side in the second direction is a front side, the roll paper holder is located on the front side with respect to the inkjet head.

12. The inkjet printer according to claim 1, wherein the positioning flange and the position determiner are made of a resin material.
